(19) United States
(12) Patent Application Publication
(10) Pub. No.: US 2009/0210424 A1
(43) Pub. Date: Aug. 20, 2009

(54) AUTHENTICATION APPARATUS AND AUTHENTICATION METHOD

(75) Inventor: Toshihiro MOROHOSHI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/356,196

(22) Filed: Jan. 20, 2009

(30) Foreign Application Priority Data
Jan. 31, 2008 (JP) 2008-021901

(51) Int. Cl. G06F 17/30; G06F 21/00

(52) U.S. Cl. 707/9; 726/28; 707/E17.005

(57) ABSTRACT

According to one embodiment, an authentication apparatus comprises a storage module configured to store permission information unique to a type of an apparatus which is permitted to access a database, a reception module configured to receive a data-acquisition request from a terminal apparatus, a check module configured to check unique information to a type of the terminal apparatus contained in the data-acquisition request with the permission information stored in the storage module, an access permitting module configured to permit the terminal apparatus to access the database when the unique information coincides with the permission information as a result of check performed by the check module.

### CROSS-REFERENCE TO RELATED APPLICATIONS

This application is based upon and claims the benefit of priority from Japanese Patent Application No. 2008-021901, filed Jan. 31, 2008, the entire contents of which are incorporated herein by reference.

### BACKGROUND

1. Field

One embodiment of the invention relates to an authentication apparatus and an authentication method for authenticating access to a database via a network.

2. Description of the Related Art

Distribution of data such as audio data, image data and content data on a network is widely practiced. A terminal apparatus such as a personal computer or a portable content reproduction apparatus, which can be connected to a network, can request data acquisition from a server apparatus connected to the network and can acquire data which the server apparatus distributes on the network.

However, some server restricts acquisition of data to terminal apparatuses allowed from the server. Jpn. Pat. Appln. KOKAI Publication No. 2002-215586 discloses an authentication apparatus that executes authentication processing based on identification information unique to each terminal apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of an electronic configuration of a content reproducing apparatus (player) 1 according to a first embodiment of the present invention;

FIG. 2 is an exemplary view showing a configuration of a server apparatus, and the player connected to the server apparatus via a network, according to the first embodiment;

FIG. 3 is an exemplary view showing a configuration of a server apparatus, and the player connected to the server apparatus via a network, according to a second embodiment;

FIG. 4 is an exemplary view showing a configuration of a server apparatus, and the player connected to the server apparatus via a network according to a third embodiment; and

FIG. 5 is an exemplary view showing a configuration of a server apparatuses, and the player connected to the server apparatus via a network, according to a fourth embodiment.

### DETAILED DESCRIPTION

Various embodiments according to the invention will be described hereinafter with reference to the accompanying drawings. In general, according to one embodiment of the invention, an authentication apparatus comprises a storage module configured to store first information indicative of a type of device which is permitted to access a database, a reception module configured to receive a data-acquisition request transmitting from a device, a check module configured to check second information indicative of a type of device contained in the data-acquisition request with the first information stored in the storage module, an access permitting module configured to permit the device to access the database when the second information coincides with the first information as a result of check performed by the check module.

Embodiments according to the present invention will now be explained hereinafter with reference to the accompanying drawings.

### First Embodiment

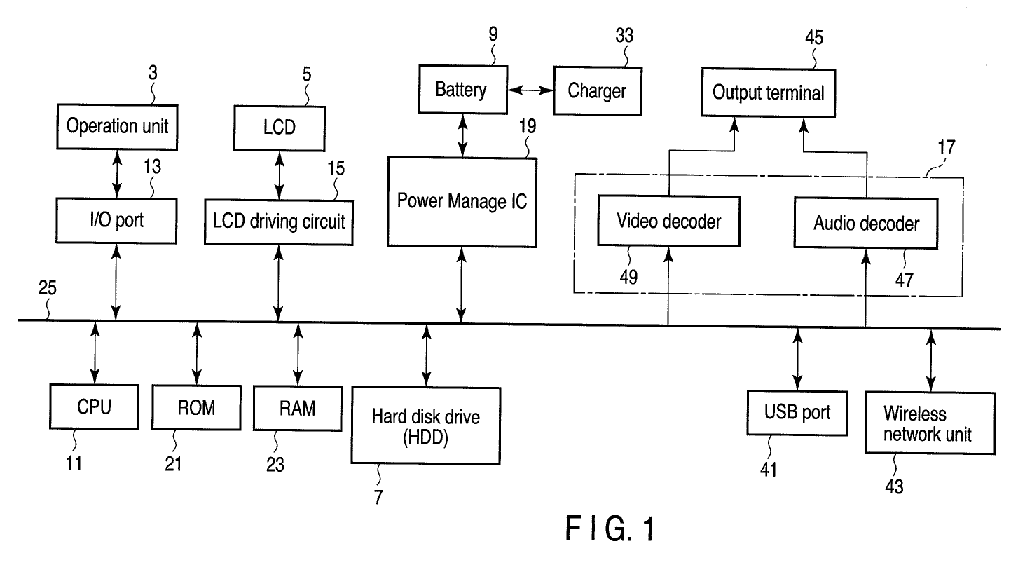

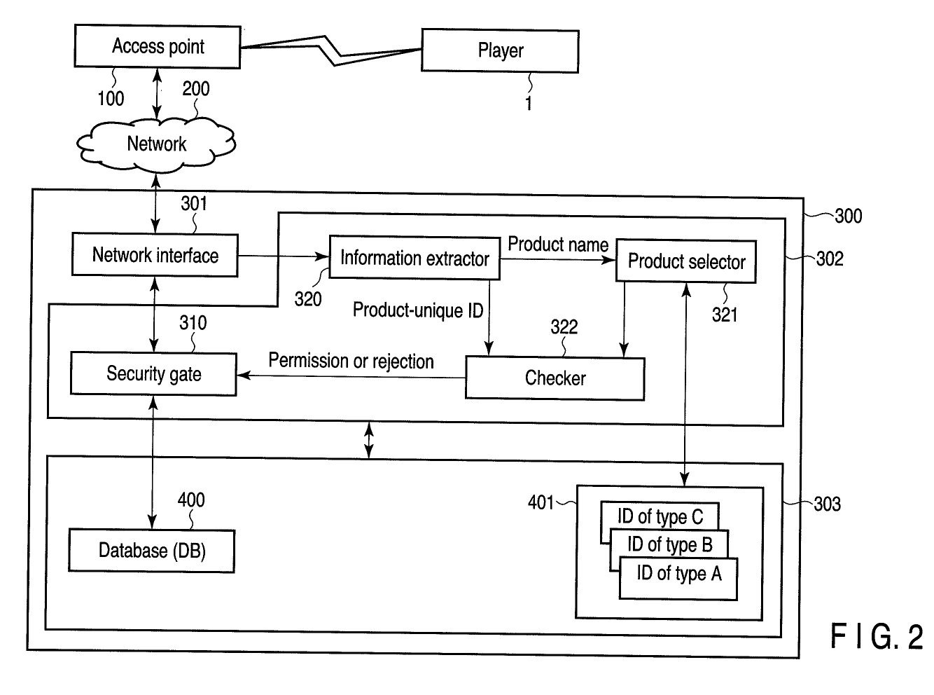

FIG. 1 is an exemplary block diagram showing an example of an electronic configuration of a content reproducing apparatus (player) 1 according to a first embodiment of the present invention. FIG. 2 is an exemplary view showing a configuration of a server apparatus, and the player 1 connected to the server apparatus via a network, according to the first embodiment. The player 1 is a portable terminal apparatus which transmits a data-acquisition request to the server apparatus 300.

The player 1 includes a CPU 11 which is a main controller. The CPU 11 controls operations of respective portions in the player 1. The respective portions in the player 1 are connected with the CPU 11 through a control bus 25.

A user can input an operation instruction and a selection instruction by operating an operation unit 3. A control signal corresponding to the operation of the operation unit 3 made by the user is supplied to the CPU 11 from an input-output (I/O) port 13. A liquid crystal display (LCD) 5 displays picture data of a moving picture, a still picture, or textual information. An LCD driving circuit 15 drives the LCD 5 under the control of the CPU 11.

A ROM 21 and a RAM 23 are connected to the CPU 11 via the control bus 25. The ROM 21 prestores program data which is to be executed by the CPU 11 to control operations of the player 1. The RAM 23 is utilized as a work memory by the CPU 11. The RAM 23 temporarily holds control information associated with a control signal and a certain amount of data read from a hard disk drive (HDD) 7.

A battery (secondary battery) 9 is utilized as a power source when the player 1 is portably carried on. A power manage IC 19 manages power provided from the battery 9, i.e., a given voltage and an allowable current. A charger 33 is connected to the battery 9.

The HDD 7 and stores various data including picture data and audio data. A flash memory or solid state disk (SSD) may be provided in place of the HDD 7. The HDD 7 may be attachable to and removable from the player 1. Alternatively, a storage device such as an SD MMC memory card, memory stick, or flash ROM may be externally attached to the player 1 in place of the HDD 7. The HDD 7 stores previously-compressed content data such as audio data, picture data or video data. A system such as MP3 or WMA is used to compress audio data, a system such as JPEG, GIF, or BMP is used to compress picture data, and a system such as WMV or MPEG-1/2/4 is used to compress video data.

The CPU 11 executes a given reproduction program prestored in the ROM 21 to reproduce a data file such as an audio data file or a picture data file stored in the HDD 7. The reproduction program for data files may be stored in the HDD 7 in advance.

An output unit 17 converts picture data or audio data into an analog output under the control of the CPU 11. An output terminal 45 is used for ordinary analog output. An audio decoder 47 which is provided in the output unit 17 demodulates audio data into an analog signal and sends the analog signal to the output terminal 45. In addition, a video decoder 49 which is provided in the output unit 17 performs digital-to-analog conversion on a video signal and outputs the converted video signal to the output terminal 45.

A Universal Serial Bus (USB) port 41 and a wireless network unit (communication unit) 43 are also connected with the CPU 11.

The player 1 can be connected with an external device (not shown) through the USB port 41 and send data to and receive data from the external device. For example, picture data or audio data is supplied to the player 1 from the external device such as a personal computer (PC) through the USB port 41. Furthermore, picture data or audio data stored in the player 1 may be supplied to the external device through the USB port 41.

Data exchange between the player 1 and the external device may utilize the wireless network unit 43. To the player 1 from the external device, picture data or audio data is supplied through the wireless network unit 43. In addition, video data or audio data stored in the HDD 7 is supplied to the external device through the wireless network unit 43. The wireless network unit 43 may comply with the Bluetooth (registered trademark) which is compatible with a protocol of communication standard using electric waves in 2.4 GHz band, or may comply with a general-purpose wireless local area network (wireless LAN) which is compatible with IEEE802. 11a/b/g/n. In addition, the wireless network unit 43 may comply with both of the Bluetooth and the general-purpose wireless LAN. The player 1 can communicate wirelessly with a server computer or a personal computer which is placed within a certain distance range from the player 1 and meets a given condition.

The player 1 can be connected to a network such as the Internet via the wireless network unit 43. Moreover, the player 1 can download a content such as an audio data file and an image data file provided on the network and store the downloaded content in the HDD 7. The player 1 can reproduce the content stored in the HDD 7.

As shown in FIG. 2, the player 1 is connected via the wireless network unit 43 to an access point 100. The access point 100 is connected to a network 200. To the network 200, a server apparatus 300 is connected. The server apparatus 300 distributes various kinds of data via the network 200.

The player 1 can exchange data with the server apparatus 300 through the network 200. In order to acquire data from the server apparatus 300, the player 1 transmits a data-acquisition request to the server apparatus 300 through the network 200.

The server apparatus 300 includes a network interface 301, a controller 302, and a storage device 303. The server apparatus 300 may further include an input device (not shown) and an output device (not shown). The network interface 301 receives a data-acquisition request transmitted from the player 1 via the network 200. When the controller 302 permits the player 1 to acquire the requested data, the data is transmitted from the network interface 301 to the player 1.

The controller 302 includes a CPU, a memory and so on, which are not shown, and controls operations of the server apparatus 300. In response to the data-acquisition request which the network interface 301 has received, the controller 302 determines whether or not to permit the data acquisition.

As the storage device 303, for example, a hard disk drive is utilized. The storage device 303 includes a database 400 and a product-information storage area 401.

The database 400 stores data which is to be distributed from the server apparatus 300 via the network 200. The database 400 may be a content database that stores audio data, picture data and video data to be distributed. Alternatively, the database 400 may be a license database that stores licenses for cancelling protection given to contents by a digital rights management (DRM) technique. The database 400 may store any other types of data.

The product-information storage area 401 holds information on a product for which data acquisition from the database 400 is permitted.

The player 1 can make access to the server apparatus 300 via the network 200 and acquire data from the database 400. However, the server apparatus 300 may restrict types of players that can access the database 400, in some cases.

For instance, an installer or administrator of the server apparatus 300 may make an agreement with a predefined manufacturer to permit a specific model of players provided by the manufacturer to acquire data from the database 400. Therefore, data distribution only to a specific model of players can be achieved.

Further, a manufacturer of players may have made an agreement with the installer or administrator of the server apparatus 300 so that anyone, who purchases a specific type of player, is permitted to acquire data from the database 400, for sales promotion.

Thus, the installer or administrator of the server apparatus 300 may permit data acquisition by type of products (or by model of products). In such a case, the controller 302 of the server apparatus 300 executes authentication processing in accordance with a type of a product which has transmitted a data-acquisition request.

The product-information storage area 401 stores data to identify a product type which is permitted to acquire data from the database 400, so as to help the controller 302 makes determination. All products of type-A manufactured by a certain manufacturer have the same identification data (product-unique ID) which is unique to and indicative of type-A. Hence, the ID unique to products of type-A is stored in the product-information storage area 401 when the installer or administrator of the server apparatus 300 permits any product of type-A to acquire data from the database 400.

The product-unique ID is defined, for example, when the installer or administrator of the server apparatus 300 makes an agreement on the data distribution with the manufacturer of the type-A products. When upper digits of serial number given to a certain component (e.g., CPU) are common to all products of type-A, the upper digits can be used as the product-unique ID.

Authentication processing for data acquisition by type of products according to the present embodiment will now be explained.

To access the server apparatus 300 and to acquire data from the database 400, the player 1 first transmits a data-acquisition request to the server apparatus 300. The data-acquisition request contains a product name and a product-unique ID of the player 1 and identification information of data to acquire. When the data-acquisition request which the player 1 transmits is an acquisition request for a license to reproduce a DRM-protected content, the data-acquisition request contains information including a manufacturer name and a product name (name of product type) of the player 1 and a product-license ID which is the product-unique ID and the name of the content to reproduce.

The network interface 301 of the server apparatus 300 receives a data-acquisition request sent through the network 200. The request which the network interface 301 receives is sent to a security gate 310 and an information extractor 320.

The information extractor 320 extracts the product name (name of product type) and the product-unique ID of the player 1 from the request transmitted from the player 1. The extracted product name is supplied to a product selector 321, and the product-unique ID is supplied to a checker 322.

The product selector 321 detects and selects a product-unique ID corresponding to the extracted product name from the product-information storage area 401. The selected product-unique ID is supplied to the checker 322. When the product-unique ID corresponding to the extracted product name is not stored in the product-information storage area 401, the checker 322 is notified that no corresponding ID is stored.

The checker 322 checks the product-unique ID supplied from the information extractor 320 with the ID selected by the product selector 321. When the product-unique ID supplied from the information extractor 320 coincides with the ID selected by the product selector, the checker 322 sends a permission notice to the security gate 310 in order to permit data acquisition from the database 400.

On the other hand, when the product-unique ID supplied from the information extractor 320 does not coincide with the ID selected by the product selector 321, the checker 322 sends a rejection notice to the security gate 310 in order not to permit data acquisition from the database 400. In addition, when no ID corresponding to the product name extracted from the request is detected from the product-information storage area 401, the checker 322 sends a rejection notice to the security gate 310 in order not to permit data acquisition from the database 400.

On receiving the permission notice from the checker 322, the security gate 310 allows the player 1 acquiring data. That is, the security gate 301 reads data which the player 1 needs to acquire from the database 400 based on the data-acquisition request sent from the network interface 301, and the read data is supplied to the network interface 301. Then the data is sent from the network interface 301 to the player 1 via the network 200.

For example, when the data-acquisition request which the player 1 has transmitted is an acquisition request for a license to reproduce the above-mentioned DRM-protected content, the security gate 310 reads the license data corresponding to the content name included in the request from the database (license database) 400 and sends the read license data to the player 1.

On the other hand, when the checker 322 sends a rejection notice to the security gate 310, the security gate 310 does not allow the player 1 acquiring data and does not access the database 400. Information for notifying that the player 1 cannot acquire data is supplied to the player 1 via the network 200.

As described above, the authentication apparatus (server apparatus) for data acquisition according to the present embodiment manages an ID unique to a product type of a player. In addition, a player transmits a data-acquisition request containing an ID unique to a type of the player to the server apparatus. The information extractor 320 extracts a product-unique ID and a product name from the data-acquisition request, and the product selector 321 reads an ID corresponding to the extracted product name from the product-information storage area 401. The checker 322 checks the extracted product-unique ID with the ID read from the product-information storage area 401. When the IDs coincide with each other, data acquisition is permitted. When the IDs do not coincide with each other, data acquisition is rejected. The security gate 310 accesses the database 400, reads requested data and transmits the read data to the player 1, only when the data acquisition is permitted. Therefore, it is sufficient that the product-information storage area 401 stores only IDs of each type of products. The product-information storage area 401 need not manage respective items of information for identifying respective products. This reduces data amount that the server apparatus 300 should manage, and decreases process load of the server apparatus 300.

In the explanation above, the database 400 and the product-information storage area 401 are prepared in the storage device 303. Nonetheless, the storage device 303 may include one or more databases. For example, the storage device 303 may include both of a content database that stores content data and a license database that stores licenses used for reproducing contents. The above authentication processing may be performed with respect to accessing one or both of the databases. Furthermore, the storage device 303 may include a menu database that is used for preparing a list of contents stored in a content database.

Other embodiments of the present invention will be described. The same portions as those of the first embodiment will be indicated in the same reference numerals and their detailed description will be omitted.

### Second Embodiment

A configuration of a content reproducing apparatus (player) 1 according to the second embodiment is shown in the block diagram of FIG. 1. Therefore, explanation of the configuration of the player 1 will be omitted.

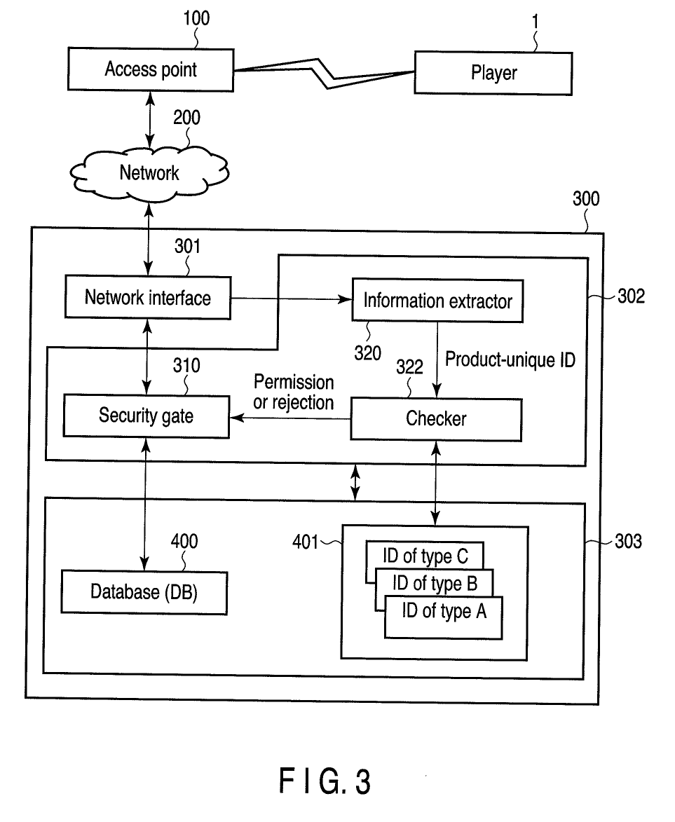

FIG. 3 is an exemplary view showing a configuration of a server apparatus, and the player 1 connected to the server apparatus via a network, according to the second embodiment.

Similarly to the first embodiment, the player 1 is connected to an access point 100 via a network unit 43. The access point 100 is connected to a network 200. To the network 200, the server apparatus 300 is connected. The server apparatus 300 distributes various kinds of data through the network 200.

The server apparatus 300 includes a network interface 301, a controller 302, and a storage device 303, as in the first embodiment. The network interface 301 is provided to exchange data with the player 1 through the network 200.

The controller 302 includes a CPU, a memory and so on, which are not shown, and controls operations of the server apparatus 300. Differently from the first embodiment, the controller 302 does not have a product selector.

The storage device 303 is, for example, a hard disk drive and includes a database 400 and a product-information storage area 401. As in the first embodiment, the database 400 stores data which is to be distributed from the server apparatus 300 via the network 200. The database 400 may be a content database that stores content data. Alternatively, the database 400 may be a license database that stores licenses for canceling protection given to DRM-protected contents. The product-information storage area 401 stores a product-unique ID indicating a type of a product permitted to acquire data from the database 400.

The player 1 can make access to the server apparatus 300 via the network 200 and acquire data from the database 400. However, the server apparatus 300 may restrict types of players that can access the database 400, in some cases.

The controller 302 of the server apparatus 300 according to this embodiment also executes authentication processing in accordance with a type of a product which has transmitted a data-acquisition request.

The product-information storage area 401 stores data to identify a product type permitted to acquire data from the database 400, so as to help the controller 302 makes determination. All products of type-A manufactured by a certain manufacturer have the same identification data (product-unique ID) which is unique to type-A. Hence, the ID unique to products of type-A is stored in the product-information storage area 401 when the installer or administrator of the server apparatus 300 permits any product of type-A to acquire data from the database 400.

Authentication processing for data acquisition by type of products according to the present embodiment will now be explained.

To access the server apparatus 300 and to acquire data from the database 400, the player 1 first transmits a data-acquisition request to the server apparatus 300. The data-acquisition request contains a product name and a product-unique ID of the player 1 and information of data to acquire. When the data-acquisition request which the player 1 transmits is an acquisition request for a license to reproduce a DRM-protected content, the data-acquisition request contains information including a manufacturer name and a product name (name of product type) of the player 1 and a product-license ID which is the product-unique ID and the name of the content to reproduce.

The network interface 301 of the server apparatus 300 receives a data-acquisition request sent through the network 200. The request which the network interface 301 receives is supplied to a security gate 310 and an information extractor 320.

The information extractor 320 extracts the product-unique ID from the transmitted request. The extracted product-unique ID is supplied to a checker 322.

The checker 322 checks the product-unique ID supplied from the information extractor 320 with IDs stored in the product-information storage area 401. When an ID that coincides with the product-unique ID supplied from the information extractor 320 is detected from the product-information storage area 401, the checker 322 sends a permission notice to the security gate 310 in order to permit data acquisition from the database 400.

On the other hand, when an ID that coincides with the product-unique ID supplied from the information extractor 320 is not detected from the product-information storage area 401, the checker 322 sends a rejection notice to the security gate 310 in order not to permit data acquisition from the database 400.

On receiving the permission notice from the checker 322, the security gate 310 allows the player 1 acquiring data. That is, the security gate 310 reads data which the player 1 needs to acquire from the database 400 based on the data-acquisition request sent from the network interface 301, and sends the read data to the network interface 301. The network interface 301 transmits the data to the player 1 via the network 200.

For example, when the data-acquisition request which the player 1 has transmitted is an acquisition request for a license to reproduce the above-described DRM-protected content, the security gate 310 reads the license data corresponding to the content name included in the request from the database (license database) 400. The read license data is transmitted to the player 1.

On the other hand, when the checker 322 sends a rejection notice to the security gate 310, the security gate 310 does not allow the player 1 acquiring data and does not access the database 400. Information for notifying that the player 1 cannot acquire data is supplied to the player 1 via the network 200.

As described above, the authentication apparatus (server apparatus) for data acquisition according to the present embodiment manages an ID unique to a product type of a player. Moreover, a player transmits a data-acquisition request containing a product-unique ID to the server apparatus. The information extractor 320 extracts the product-unique ID from the data-acquisition request, and the checker 322 detects an ID which coincides with the extracted product-unique ID from the product-information storage area 401. When an ID which coincides with the extracted product-unique ID is detected, data acquisition is permitted. When an ID which coincides with the extracted product-unique ID is not detected, data acquisition is rejected. Only when the data acquisition is permitted, the security gate 310 accesses the database 400, reads the requested data from the database 400, and supplies the read data to the player 1. Thus, the product-information storage area 401 may store only IDs of respective types of products and need not manage respective items of information for identifying respective products. This reduces data amount that the server apparatus 300 should manage, and decreases process load of the server apparatus 300.

In the present embodiment, the checker 322 is required to check the extracted product-unique ID with every ID stored in the product-information storage area 401. However, IDs stored in the product-information storage area 401 are set individually for each type of products, and therefore, limited in numbers. Accordingly, the process load of the server apparatus 300 would not increase so much.

In the above description, the storage device 303 includes the database 400 and the product-information storage area 401. However, the storage device 303 may include one or more databases. For example, the storage device 303 may include both of a content database that stores content data and a license database that stores licenses used for reproducing contents. The above authentication processing may be performed for accessing one or both of the databases. Moreover, the storage device 303 may include a menu database that is used for preparing a list of contents stored in a content database.

### Third Embodiment

A configuration of a content reproducing apparatus (player) 1 according to the third embodiment is shown in the block diagram of FIG. 1. Therefore, explanation of the configuration of the player 1 will be omitted.

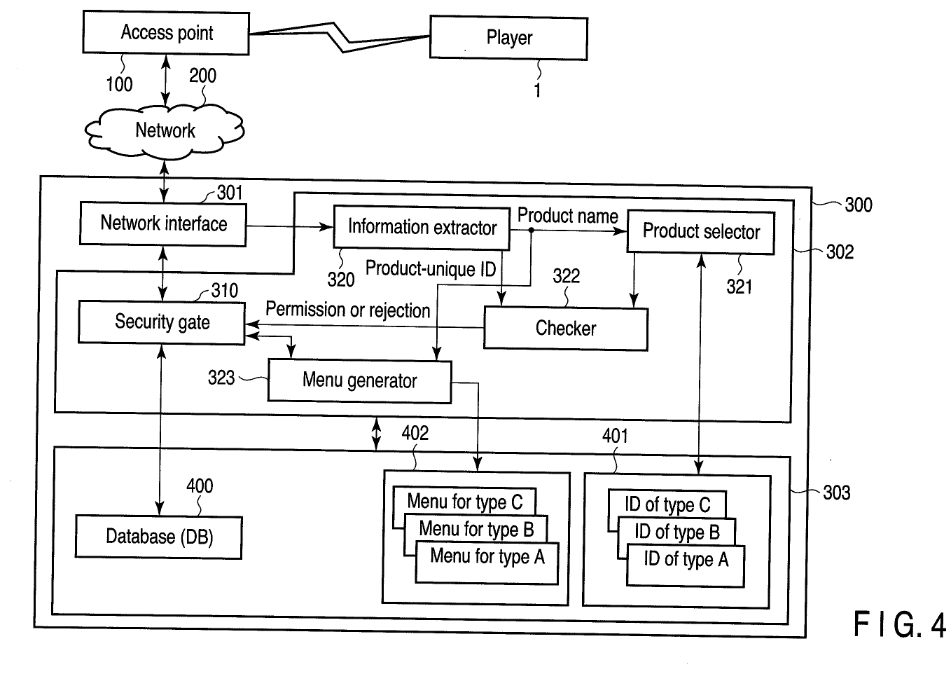

FIG. 4 is an exemplary view showing a configuration of a server apparatus, and the player 1 connected to the server apparatus via a network, according to the third embodiment.

Similarly to the first embodiment, the server apparatus 300 includes a network interface 301, a controller 302 and a storage device 303. The network interface 301 is used to exchange data with the player 1 via the network 200.

The controller 302 includes a CPU, a memory and so on, which are not shown, and controls operations of the server apparatus 300. In the present embodiment, the controller 302 includes a security gate 310, an information extractor 320, a product selector 321, a checker 322 and a menu generator 323.

The storage device 303 is, for example, a hard disk drive and includes a database 400, a product-information storage area 401 and a menu storage area 402. The database 400 stores data which is to be distributed from the server apparatus 300 through the network 200. The menu storage area 402 stores data for generating a menu corresponding to a type of a product.

Authentication processing for data acquisition by type of products according to the present embodiment will now be described. In the authentication processing according to the present embodiment, operations similar to the first embodiment will not be described in detail.

When the player 1 transmits a data-acquisition request for acquiring menu data, the following operations will be executed.

The data-acquisition request from the player 1 which is received by the network interface 301 is sent to the security gate 310 and the information extractor 320.

The information extractor 320 extracts a product name and a product-unique ID from the data-acquisition request. The extracted product name is sent to the product selector 321 and the menu generator 323. The extracted product-unique ID is sent to the checker 322.

The menu generator 323 detects and selects menu data corresponding to the extracted product name from the menu storage area 402. The selected menu data is supplied to the security gate 310.

The product selector 321 detects and selects a product-unique ID corresponding to the extracted product name from the product-information storage area 401 of the storage device 303. The checker 322 checks the product-unique ID sent from the information extractor 320 with the ID selected by the product selector 321, and the checker 322 determines whether or not to permit the data acquisition.

On receiving a permission notice for the data acquisition from the checker 322, the security gate 310 allows the player 1 acquiring data. More precisely, the security gate 310 transmits the menu data sent from the menu generator 323 to the network interface 301. The network interface 301 transmits the menu data to the player 1 via the network 200. The player 1 can display a menu screen generated from the menu data. The menu screen includes, for example, a list of contents that the server 300 distributes.

When rejection of the data acquisition is notified from the checker 322, the security gate 310 does not allow the player 1 acquiring data. Information for notifying that the player 1 cannot receive data is transmitted to the player 1 via the network 200.

In the present embodiment, menu data is transmitted to the player 1 when a permission notice is sent to the security gate 310. Instead, the menu data may be sent directly from the menu generator 323 to the network interface 301, not via the security gate 310. In this case, determination whether or not to permit data acquisition will not be made. Hence, any player can acquire the menu data. Though, the data stored in the database 400 should be acquired via the security gate 310.

When a data-acquisition request, which is transmitted from the player 1, requests data stored in the database 400, the data may be transmitted to the player 1 by means of the same operation as performed in the first embodiment. In the case where the authentication processing has already been executed with respect to menu data acquisition, when data acquisition is requested based on the menu data, further authentication processing may not be performed.

### Fourth Embodiment

A configuration of a content reproducing apparatus (player) 1 according to the fourth embodiment is illustrated in the block diagram of FIG. 1. Therefore, explanation of the configuration of the player 1 will be omitted.

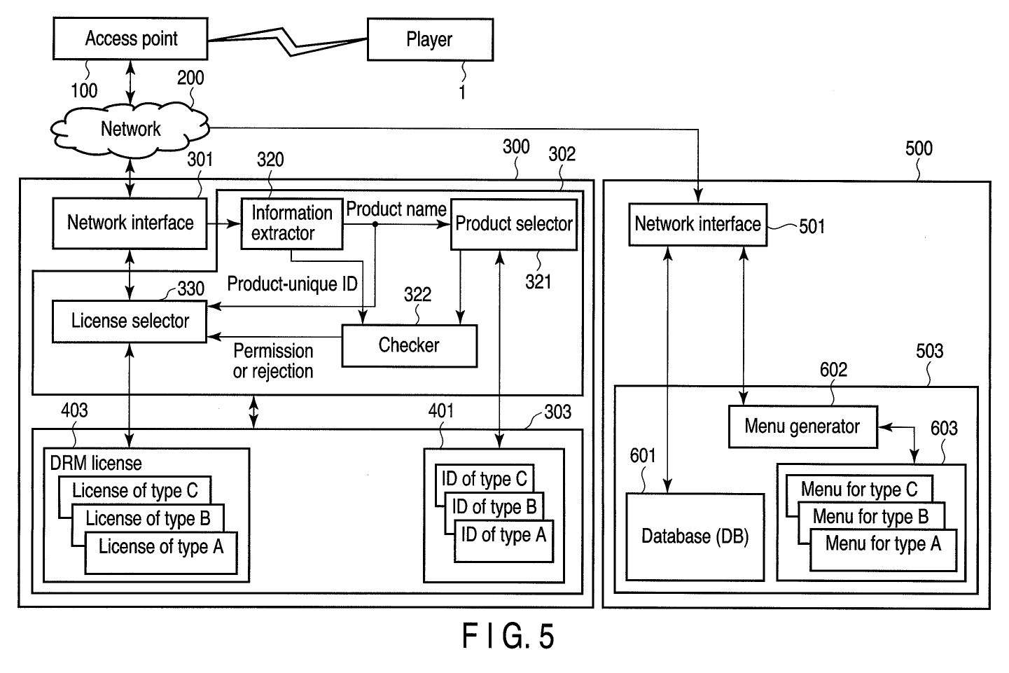

FIG. 5 is an exemplary view showing a configuration of a server apparatuses, and the player 1 connected to the server apparatus via a network, according to the fourth embodiment. In the present embodiment, two server apparatuses 300 and 500 are connected to a network 200.

The server apparatus 500 distributes DRM-protected data. The server apparatus 500 includes a network interface 501 and a distributing unit 503. The server apparatus 500 is accessible to any type of player.

The distributing unit 503 includes a database (DB) 601, a menu generator 602, and a menu storage area 603. The database 601 stores data which can be distributed.

The menu storage area 603 stores data for generating a menu corresponding to a type of a product. The menu generator 602 extracts a product name contained in a data-acquisition request and generates menu data corresponding to the product name. The generated menu data is transmitted to the player 1 via the network interface 501.

The network interface 501 receives a data-acquisition request transmitted from the player 1. The distributing unit 503 sends data corresponding to the data-acquisition request to the network interface 501. The data corresponding to the request is transmitted from the network interface 501 to the player 1. When a data-acquisition request which requests menu data is received, the network interface 501 transmits menu data sent from the menu generator 602. When a data-acquisition request which requests data stored in the database 601 is received, the network interface 501 transmits the data stored in the database 601.

Data stored in the database 601 may be protected with the DRM technique (DRM-protected). In such a case, the player 1 cannot decode and reproduce the data if the player 1 does not have a corresponding license. The server apparatus 300 distributes license for reproducing DRM-protected data which the server apparatus 500 distributes. The player 1 needs to obtain the license distributed by the server apparatus 300.

As in the first embodiment, the server apparatus 300 includes a network interface 301, a controller 302 and a storage device 303. The network interface 301 is used to exchange data with the player 1 via the network 200.

The controller 302 includes a CPU, a memory and so on, which are not shown, and controls operations of the server apparatus 300. In the present embodiment, the controller 302 includes an information extractor 320, a product selector 321, a checker 322, and a license selector 330.

The storage device 303 is, for example, a hard disk drive and includes a product-information storage area 401 and a DRM license database 403. The product-information storage area 401 stores data (product-unique ID) for identifying a product type permitted to obtain a license. All products of type-A manufactured by a certain manufacturer have the same identification data (product-unique ID) which is unique to type-A. The DRM license database 403 stores licenses for reproducing DRM-protected data distributed from the server apparatus 500. A license to be stored in the DRM license database 403 is set individually for each of types of products. Hence, in order to reproduce an item of DRM-protected data by a product of type-A, acquisition of a license corresponding to type-A is required.

Authentication processing for data acquisition by type of products according to the present embodiment will now be explained. Operations similar to the first embodiment will not be described in detail.

The network interface 301 receives a data-acquisition request from the player 1, and the data-acquisition request is transmitted to the license selector 330 and to the information extractor 320.

The information extractor 320 extracts a product name and a product-unique ID of the player 1 from the data-acquisition request. The extracted product name is sent to the product selector 321 and the license selector 330. The extracted product-unique ID is sent to the checker 322.

The product selector 321 detects and selects a product-unique ID corresponding to the extracted product name from the product-information storage area 401 of the storage device 303. The checker 322 checks the product-unique ID sent from the information extractor 320 with the ID selected by the product selector 321, and the checker 322 determines whether or not to permit data acquisition.

On receiving a permission notice for the data acquisition from the checker 322, the license selector 330 allows the player 1 acquiring data. More precisely, the license selector 330 detects and selects license data corresponding to the extracted product name from the DRM license database 403. The selected license data is sent to the network interface 301. The DRM license corresponding to the product name (or product-unique ID) of the player 1 is sent from the network interface 301 to the player 1 via the network 200.

On the other hand, when rejection of the data acquisition is notified from the checker 322, the license selector 330 does not allow the player 1 acquiring data. Information for notifying that the player 1 cannot acquire data is transmitted to the player 1 via the network 200.

In the present embodiment, the product name extracted by the information extractor 320 is transmitted to the license selector 330. Instead, the product-unique ID extracted by the information extractor 320 may be transmitted to the license selector 330, and the license selector 330 may detect and select the DRM license in accordance with the product-unique ID.

Licenses stored in the DRM license database 403 need not correspond to product types one by one. For example, such configuration is possible that license Z corresponds to products of types A and B, while license Y corresponds to the products of type C.

As described above, according to the above embodiments of the present invention, access to a database can be restricted by type of a terminal apparatus. Therefore, for instance, in the case where a license agreement with respect to content distribution has been made between Company A that manufactures players and Company B that installs or administrates a server apparatus, when the license agreement expires, a product-unique ID of a player provided by Company A can be deleted from the product-information storage area 401. Thereby, the service thus far given to the player is terminated.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules, or components on one or more computers, such as servers. While the various modules are illustrated separately, they may share some or all of the same underlying logic or code.

What is claimed is:

1. An authentication apparatus comprising:
a storage module configured to store first information indicative of a type of device permitted to access a database;
a receiver configured to receive a data-acquisition request transmitted from a device;
a checking module configured to check second information indicative of a type of device in the data-acquisition request with the first information stored in the storage module;
an access permitting module configured to permit the device to access the database when the second information corresponds with the first information as a result of check performed by the checking module.

2. The authentication apparatus of claim 1, further comprising an extraction module configured to extract the second information from the data-acquisition request,
wherein the checking module is configured to check the second information extracted by the extraction module with the first information stored in the storage module.

3. The authentication apparatus of claim 1, wherein the storage module is configured to store the first information in association with the type of device permitted to access the database,
and the authentication apparatus further comprising a detection module configured to detect first information corresponding to the type of device in the data-acquisition request from information stored in the storage module,
and wherein the checking module is configured to check the second information with the first information detected by the detection module.

4. The authentication apparatus of claim 3, further comprising:
an extraction module configured to extract the type of device and the second information from the data-acquisition request; and
a detection module configured to detect first information corresponding to the extracted type of device from information stored in the storage module,
and wherein the checking module is configured to check the second information extracted by the extraction module with the first information detected by the detection module.

5. The authentication apparatus of claim 1, wherein the access permitting module is configured to read data requested by the data-acquisition request from the database and to transmit the data to the device when the second information corresponds with the first information.

6. The authentication apparatus of claim 1, wherein the database comprises a content database configured to store a content to be distributed on a network.

7. The authentication apparatus of claim 1, wherein the database comprises a license database configured to store a license for canceling protection given to a content.

8. An authentication method comprising:
storing first information in a storage module;
receiving a data-acquisition request transmitted from a device;
checking second information indicative of a type of device in the data-acquisition request with the first information indicative of a type of device permitted to access a database; and
permitting the device to access the database when the second information corresponds with the first information.

9. The authentication method of claim 8, further comprising extracting the second information from the data-acquisition request,
and wherein the extracted second information is checked with the first information stored in the storage module.

10. The authentication method of claim 8, wherein the storage module is configured to stores the first information in association with the type of device permitted to access the database,
and the authentication method further comprising detecting first information corresponding the type of device in the data-acquisition request from information stored in the storage module,
and wherein the second information in the data-acquisition request is checked with the detected first information.

11. The authentication method of claim 8, further comprising:
extracting the type of device and the second information from the data-acquisition request; and
detecting first information corresponding to the extracted the type of device from information stored in the storage module,
and wherein the extracted second information is checked with the detected first information.

12. The authentication method of claim 8, further comprising:
reading data requested by the data-acquisition request from the database; and
transmitting the data to the device when the second information corresponds with the first information.
